(19) United States
(12) Patent Application Publication
(10) Pub. No.: US 2026/0119136 A1
(43) Pub. Date: Apr. 30, 2026

(54) METHOD AND SYSTEM FOR EFFICIENT, CUSTOMIZABLE ARTIFICIAL INTELLIGENCE (AI)-DRIVEN PROGRAM CODE GENERATION FROM NATURAL LANGUAGE INPUT PROMPTS BASED ON LARGE-LANGUAGE MODELS (LLMS)

(71) Applicant: AUTHENTIX, INC., ADDISON, TX (US)

(72) Inventor: Jamie KAWABATA, GARLAND, TX (US)

(21) Appl. No.: 19/365,090

(22) Filed: Oct. 21, 2025

Related U.S. Application Data
(60) Provisional application No. 63/711,666, filed on Oct. 24, 2024.

(51) Int. Cl. G06F 8/35; G06F 8/36; G06F 11/3604; G06F 11/3668

(52) U.S. Cl. CPC G06F 8/35; G06F 8/36; G06F 11/3604; G06F 11/3688

(57) ABSTRACT

A computer-implemented method for providing artificial intelligence (AI)-driven program code generation from a natural language input prompt, the method comprising initiating an LLM process to generate first code for accomplishing a task, wherein the initiating comprises providing, to a first LLM, a sequence of steps in natural language and a reference to a code datastore comprising functions; receiving, from the first LLM, the first code; evaluating the first code to determine whether the first code satisfies criteria; and reinitiating the LLM process to generate second code for accomplishing the task based on the first code failing to satisfy the criteria, wherein the reinitiating the LLM process comprises providing, to a second LLM, the sequence of steps in natural language, the reference to the code datastore, and feedback; receiving, from the second LLM, the second code; and outputting the second code based on the second code satisfying the criteria.

### CROSS-REFERENCE TO RELATED APPLICATIONS

The present application claims priority to U.S. Provisional Application No. 63/711,666 filed with the United States Patent and Trademark Office on Oct. 24, 2024 and entitled “METHOD AND SYSTEM FOR EFFICIENT, CUSTOMIZABLE ARTIFICIAL INTELLIGENCE (AI)-DRIVEN PROGRAM CODE GENERATION FROM NATURAL LANGUAGE INPUT PROMPTS BASED ON LARGE-LANGUAGE MODELS (LLMS),” which is incorporated herein by reference in its entirety for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Natural language processing (NLP) is a branch of artificial intelligence (AI) technology that focuses on interaction between computers and humans through natural language. For instance, NLP may use machine learning (ML) to provide computers with the ability to interpret, manipulate, comprehend, and extrapolate human language and to respond using human-like language. Recent advancements in NLP include the development of large-language models (LLMs) (e.g., generative pre-trained transformer (GPT) models, bidirectional encoder representations from transformer (BERT) models, etc.). An LLM may have a large number of parameters (e.g., thousands, millions, or billions of parameters) trained on large datasets (e.g., text data). The LLM may be trained to learn complex patterns and dependencies in language to generate text (e.g., for answering questions) that is coherent, contextually relevant, and often indistinguishable from text written by humans. As such, LLM can be beneficial to a wide variety of applications, generally any application where natural language understanding and generation is valuable.

### SUMMARY

In an embodiment, a computer-implemented method for providing artificial intelligence (AI)-driven program code generation from a natural language input prompt based on multiple large-language model (LLM) iterations with LLM iteration evaluation is provided. The method comprises initiating, by a natural language-based code generation agent, an LLM process to generate first program code for accomplishing a specific task, wherein the initiating comprises providing, to a first LLM, a sequence of steps in natural language to accomplish the specific task and a reference to a code datastore comprising a plurality of functions; receiving, by the natural language-based code generation agent, from the first LLM, the first program code for accomplishing the specific task, wherein the first program code comprises a subset of the plurality of functions of the code datastore; evaluating, by the natural language-based code generation agent, the first program code generated by the first LLM to determine whether the first program code satisfies one or more criteria; and reinitiating, by the natural language-based code generation agent, the LLM process to generate second program code for accomplishing the specific task based on the first program code generated by the first LLM failing to satisfy the one or more criteria, wherein the reinitiating the LLM process comprises providing, to a second LLM, the sequence of steps in natural language, the reference to the code datastore, and feedback associated with a failure of the first program code in satisfying the one or more criteria; receiving, by the natural language-based code generation agent, from the second LLM, the second program code for accomplishing the specific task, wherein the second program code comprises a second subset of the plurality of functions of the code datastore; and outputting, by the natural language-based code generation agent, the second program code based on the second program code satisfying the one or more criteria.

In another embodiment, a computer-implemented method for providing efficient artificial intelligence (AI)-driven program code generation from natural language step-by-step processes based on one or more large-language models (LLMs) with composite function generation is provided. The method includes receiving, by a natural language-based code generation agent comprising instructions stored in non-transitory memory of a computer system and executable by a processor of the computer system, an input prompt comprising a natural language step-by-step process, wherein the natural language step-by-step process comprises a sequence of steps associated with a specific task; analyzing, by the natural language-based code generation agent, the sequence of steps against a function availability of a code datastore comprising a plurality of functions, wherein the plurality of functions comprises a plurality of base-level functions and one or more composite functions, each invoking at least two of the plurality of base-level functions, wherein the analyzing comprises determining whether there is a match between at least two steps of the sequence of steps and a first composite function of the one or more composite functions; generating, by the natural language-based code generation agent, based on determining the match between the at least two steps and the first composite function, a shortened sequence of steps by combining the at least two steps; and mapping the shortened sequence of steps to a subset of the plurality of functions comprising the first composite function; initiating, by the natural language-based code generation agent, an LLM to generate, based on the mapped subset of the plurality of functions, program code for the shortened sequence of steps; receiving, by the natural language-based code generation agent, from the LLM, the program code for the natural language step-by-step process; and outputting, by the natural language-based code generation agent, in response to the input prompt, the LLM generated program code.

In yet another embodiment, a computer-implemented method for providing artificial intelligence (AI)-driven program code generation from a natural language program code target result based on one or more large-language models (LLMs) is provided. The method comprises receiving, by a natural language-based code generation agent comprising instructions stored in non-transitory memory of a computer system and executable by a processor of the computer system, an input prompt comprising a target program code resulting in natural language; determining, by the natural language-based code generation agent, based on a function availability of a code datastore, a sequence of steps in natural language to provide the target program code result, wherein the code datastore comprises a plurality of functions, each in association with metadata comprising a textual description of at least one of a functionality or a function call interface of a respective one of the plurality of functions; initiating, by the natural language-based code generation agent, an LLM to generate, based on the code datastore and the determined sequence of steps, program code for providing the target program code result; receiving, by the natural language-based code generation agent, from the LLM, the program code for providing the target program code result, wherein the program code comprises a subset of the plurality of functions of the code datastore; and outputting, by the natural language-based code generation agent, in response to the input prompt, the program code for providing the target program code result.

In yet another embodiment, a computer-implemented method for providing artificial intelligence (AI)-driven program code generation from natural language input based on one or more large-language models (LLMs) and a code datastore with code datastore maintenance for efficiency improvement. The method comprises initiating, by a natural language-based code generation agent, an LLM to generate program code for accomplishing a specific task, wherein the initiating comprises providing, to the LLM, a sequence of steps in natural language to accomplish the specific task and a reference to a code datastore comprising a plurality of functions, wherein at least a first function and a second function of the plurality of functions provide the same functionality but comprises different code instructions; receiving, by the natural language-based code generation agent, from the LLM, the program code for accomplishing the specific task, wherein the program code comprises one of the first function or the second function; evaluating, by the natural language-based code generation agent, the first function and the second function based on one or more criteria; and updating, by the natural language-based code generation agent, the code datastore based on the evaluating.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system that provides efficient, customizable artificial intelligence (AI)-driven code generation from natural language input prompts using large-language models (LLMs) according to an embodiment of the disclosure.

FIG. 2 is a block diagram illustrating an example code datastore according to an embodiment of the disclosure.

FIGS. 3A and 3B are flow charts illustrating an example method for providing efficient, customizable AI-driven code generation from a natural language step-by-step process according to an embodiment of the disclosure.

FIG. 4 is a flow chart illustrating an example method for providing efficient, customizable AI-driven code generation from a natural language target program code result according to an embodiment of the disclosure.

FIG. 5 is a flow chart of a method according to an embodiment of the disclosure.

FIG. 6 is a flow chart of another method according to an embodiment of the disclosure.

FIG. 7 is a flow chart of yet another method according to an embodiment of the disclosure.

FIG. 8 is a flow chart of yet another method according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

While large-language models (LLMs) can be employed in a wide variety of applications (e.g., authentication services, anti-counterfeiting services, brand protection services, customer service chatbots, research summarization, medical diagnostics, financial analysis, etc.) to automate various workflows, any LLM-driven workflow generally requires complex software to be developed (e.g., coding and/or scripting in Python, JavaScript, C, C++, etc.). However, software development is often outside the skill set of non-technical users (e.g., organizational leaders, business leaders, subject matter experts, etc.). As such, non-technical users may rely on software developers to bridge the gap for developing those automation tools. In some situations, the software needs may not be fully met by the software developers, for example, in terms of functionalities and/or production schedules. Thus, it may be desirable to provide programing tools that are based on natural language (i.e., using English as a programming language) to enable non-technical users or non-technical subject matter experts to write program code.

While there are AI-driven or LLM-driven web applications that can generate program code given a natural-language (human-language) prompt, these web applications may be unsuitable for automating internal tasks or workflows of an organization or enterprise. For instance, web applications may be constrained on the data that they operate on, where the data may have to be cloud-based or web-accessible, or the files may have to be uploaded for processing. For large-size files like videos, having to upload is a significant inefficiency. This is inherent in web browsers because, by design, they do not have access to files on a person's local computer, nor can they access other programs on a person's local computer. As a result, AI-driven or LLM-driven web-based tools may be limited in scope in the data they can access and/or the programs and/or hardware they can interact with. Furthermore, security and data privacy may prohibit the use of AI-driven or LLM-driven code generation tools that are web-based as data may have to reside in cloud storage.

The present disclosure provides a technical solution to the aforementioned technical problems in the technical field of NLP-based or AI-based program code generation to provide a custom AI-driven software framework for generating program code from natural language based on LLMs. The custom AI-driven software framework allows for unlimited control of application logic (e.g., functional units or building blocks for generating program code), tailored to the specific needs of an individual or organization. In contrast to AI-driven or LLM-driven web-based tools, the custom AI-driven software framework can use local resources (e.g., text files, images, code, video files, or other documents) and network-connected resources (e.g., web interfaces like Google or Wikipedia, online email application programming interfaces (APIs)). The custom AI-driven software framework can also provide data privacy and security by having data stored and processed locally (e.g., within a local network of an organization or enterprise).

According to an embodiment of the present disclosure, the custom AI-driven software framework may include a code datastore, LLMs, library check tools, code programming and testing tools (e.g., program language-specific tools including compiler tools, simulators, debuggers, functional testing tools, etc.), and a computer system including a natural language-based code generation agent. The computer system may be a local machine or server of an individual or an organization, and the natural language-based code generation agent may be a software application that executes locally on the local machine. The natural language-based code generation agent may receive an input prompt in natural language providing instruction(s) for generating program code to accomplish a certain task or to solve a certain problem (e.g., related to authentication services, anti-counterfeiting services, brand protection services, customer service chatbots, research summarization, medical diagnostics, financial analysis, LLM-based automations, etc.). The instruction(s) in the input prompt can be in the form of a natural language step-by-step process (including individual steps) or a natural language target program code result (without individual steps). The natural language-based code generation agent may invoke an LLM to generate the program code for accomplishing the certain task using the code datastore.

The code datastore may include annotated functions (e.g., multiple functions, each in association with respective metadata), which are the building blocks for generating program code. The functions may include program code in a certain programming and/or scripting language (e.g., Python, JavaScript, C, C++, etc.). The functions of the code datastore may include base-level functions and composite functions.

A function is a callable unit of software logic (e.g., a block of program code) that has a well-defined interface and behavior and can be invoked multiple times. As used herein, a base-level function may refer to a function that performs a single specific task. A base-level function may not invoke any other base-level function. Examples of base-level functions may include, but are not limited to, analyzing a document and producing a summary, analyzing program code and producing suggestions or improvements in natural language (e.g., English), and generating specific product ideas given a certain product category. Other examples of base-level functions may perform local actions, such as reading a file, creating a file, zipping files into archives, compiling source code into a program, executing a program, or interacting with a program that simulates certain operations (e.g., mouse clicks), that do not involve LLM or any online application program interface (API) calls.

As used herein, a composite function may refer to a function that invokes at least two functions (which may include base-level functions and/or other composite functions). In some instances, a composite function may be a linear sequence of base-level function calls. In other instances, a composite function can include conditional execution of base-level functions with looping (e.g., generating code, testing code, repairing code in a loop until the code passes a certain test). As will be discussed more fully below, the natural language-based code generation agent may augment the code datastore (e.g., based on certain analysis) by creating composite functions using LLM(s) and storing the created composite functions in the code datastore (e.g., a part of post-processing after generating program code).

The metadata in the code datastore may include a variety of information associated with the usage, the creation, and/or the execution of the respective functions. In an example, the metadata for a particular function may include a textual description of a functionality (or a behavior), a function interface call (e.g., how to call the function), a run-time processing resource utilization (e.g., a number of instruction cycles for executing the particular function), and/or a run-time memory resource utilization (e.g., a number of bytes for storing local and global variables of the particular function) associated with the particular function. Additionally, the metadata may include information associated with the creation of the particular function (e.g., programming language used, LLM models and versions used, etc.). For instance, metadata for a function created by a certain LLM may include an LLM model type (e.g., OpenAI® models such as ChatGPT) and/or an LLM model version (e.g., ChatGPT-3, ChatGPT-3.5, ChatGPT-4, ChatCPT-4 turbo etc.) of the certain LLM. Additionally, the metadata may include execution or performance related information associated with the particular function. For instance, the metadata may include a first counter to track the number of times the particular function has been invoked by a caller function, a second counter to track the number of times the particular function has been invoked with a successful result for the caller function, and/or a third counter to track the number of times the particular function has been invoked with a failure result for the caller function. Additionally, the metadata may optionally include a weighting value associated with the particular function. For example, in some instances, the code datastore may include multiple functions with the same functionality but different code instructions as will be discussed more fully below. In such instances, a weighting value may be assigned to each of those functions (with the same functionality) based on their relative performance or efficiency.

In one embodiment, the input prompt may include a natural language step-by-step process (e.g., a natural language algorithm). The natural language step-by-step process may include a sequence of steps in natural language for accomplishing a certain task. As an example, the input prompt may include a first step to read a text file (e.g., in English), a second step to convert the text file from English to Spanish, and a third step to output the Spanish translated text in portable document format (PDF) document. Upon receiving the input prompt, the natural language-based code generation agent may provide the sequence of steps in the natural language step-by-step process and the code datastore to an LLM. The LLM may parse the sequence of steps and map the parsed steps to corresponding functions of the code datastore. As part of the mapping, the LLM may interpret each step in the sequence and the metadata of the code datastore to search for a function with a functionality that matches the respective step. Subsequently, the LLM may construct the program code by including function calls to the mapped functions (e.g., according to the order of the steps in the sequence). As part of constructing the program code, the LLM may interpret the metadata in the code datastore to construct the function calls with input and/or output parameters according to the respective metadata (or more specifically, the function call interfaces) of the mapped functions.

Subsequently, the natural language-based code generation agent may receive the LLM generated program code from the LLM and output the LLM generated code in response to the input prompt. Referring to the Spanish translation example discussed above, the code datastore may include a read text file function that reads a text file, a Spanish translation function (e.g., from English to Spanish), and a write PDF document function, and the LLM generated program code may include the three individual functions (the read text file function, the Spanish translation function, and the write PDF document function).

To ensure the accuracy and/or efficiency of the LLM generated program code, the natural language-based code generation agent may utilize the code programming and testing tools to evaluate the accuracy and/or efficiency of the LLM generated program code. As part of the evaluation, the natural language-based code generation agent may determine whether the LLM generated program code satisfies one or more criteria. The one or more criteria may include at least one of a compiler test with no error, all functional tests with no error, a runtime efficiency threshold being satisfied, or no detected code violation. As such, as part of the evaluation, a set of tests (e.g., a compiler test, a functional test, etc.) and/or a set of constraints (e.g., related to runtime efficiency, code violation, etc.) may be applied to the LLM generated program code.

To perform a compiler test, the natural language-based code generation agent may utilize a compiler tool to compile the LLM generated program code. If the compiler returns no error, the compiler test is successful. If, however, the compiler returns an error, the compiler test fails. To perform a functional test, the natural language-based code generation agent may utilize a functional testing tool (e.g., a simulator, a debugger, a functional-specific tester, automation testing scripts, etc.) to test a functionality of the LLM generated program code against a set of predetermined test cases (e.g., each with a defined input and an expected output or expected score). If the functional testing tool returns no error for all the test cases (e.g., the LLM generated code outputs from all the test cases are as expected), the functional test is successful. If, however, an error or a failure occurs for any one of the test cases (e.g., the LLM generated code outputs from one or more of the test cases are not as expected), the functional test fails.

To test for runtime efficiency, the natural language-based code generation agent may obtain an indication of a processing resource utilization (e.g., in terms of a number of instruction cycles) and/or a memory resource utilization (e.g., in terms of a number of bytes used for storing global and/or local variables and/or a stack) measured during runtime (e.g., while a functional test is being executed). The natural language-based code generation agent may determine whether the runtime efficiency satisfies a certain threshold (e.g., a threshold number of instruction cycles for processor usage or a threshold number of bytes for memory usage). To test for code violation, the natural language-based code generation agent may inspect and analyze the LLM generated code to determine whether the LLM generated code includes functions outside of a list of predetermined allowable functions and/or functions within a list of predetermined disallowable functions (e.g., to allow for a measure of safety). Examples of allowable functions may include, but are not limited to, “append( )” and “print( ).” Examples of disallowable function may include, but are not limited to, “delete( )” and “send_money( ).” Other examples of code violations may be based on a set of predetermined coding rules (e.g., not to include infinite loops, deeply nested functions that are more than a threshold number of levels deep, etc.). Coding rules may include categorically disallowing importing of external libraries, which can be validated at a syntactic level, or avoiding incremental appends to a string within a loop. In a further example, a coding rule may require sanitation or validation of external inputs.

If the natural language-based code generation agent determines that the LLM generated program code fails to satisfy the one or more criteria, the natural language-based code generation agent may reinitiate the LLM to generate program code for the natural language step-by-step process until the LLM outputs program code that satisfies the one or more criteria. As part of the reinitiation, the natural language-based code generation agent may provide the LLM with the sequence of steps, the code datastore, and additionally feedback (or observation) obtained from the evaluation. The feedback may include error(s) received from certain tests during the evaluation.

In some instances, the natural language-based code generation agent may initially utilize a less robust (or lower cost in terms of computational resources, memory resources, etc.) LLM to generate the program code and may switch to utilize a more robust (or higher cost in terms of computational resources, memory resources, etc.) LLM to generate the program code when the number of failures or the number of re-initiations exceed a certain threshold (e.g., 1, 2, 3, 4 or more). Generally, the less robust LLM and the more robust LLM may include different model attributes (e.g., different LLM model types, different versions of a particular LLM model, different transformer architectures, trained on different types of data and/or different amounts of data, etc.). In some instances, the natural language-based code generation agent may further update the execution or performance related information (e.g., the success/failure counters) in the metadata of the code datastore for the respective functions invoked in the LLM generated code based on the evaluation.

In some instances, the natural language-based code generator agent may utilize the library check tools to analyze the LLM generated program code to determine whether there are any composite functions to be created and stored in the code datastore (e.g., after the evaluation of the LLM generated code indicates a pass). Continuing with the Spanish translation example discussed above, the natural language-based code generator agent may generate a composite function for converting a text file to a Spanish PDF document made up of the three individual functions (the read text file function, the Spanish translation function, and the write PDF document function) of the code datastore. More specifically, the composite function may invoke the read text file function, the Spanish translation function, and the write PDF document function in the same order as the sequence of steps.

The determination of whether there are any composite functions to be created and stored in the code datastore may be based on a variety of factors (e.g., whether a combination of two or more functions perform a meaningful or useful task, whether a combination of the two or more functions may improve processing and/or memory utilization efficiency, a frequency of occurrences of the two or more functions being invoked consecutively across a number of software programs, etc.). The determination for combining functions to create a composite function may generally be based on two criteria: (1) the description of the composite function is to be semantically meaningful and simple relative to what the composite function does; and (2) the composite function is likely to be reused, meaning that other contexts exist or can be envisioned where the function may be used again. Generally, the composite function may include all functions in the LLM generated code or less than all of the functions in the LLM generated code.

After the composite function is generated, the natural language-based code generation agent may generate metadata for the composite function. The generated metadata may include a textual description of functionality and/or a function call interface of the composite function, a processing resource utilization and/or a memory resource utilization of the generated composite function, and/or the LLM model type and/or LLM model version used for creating the composite function. The natural language-based code generation agent may store the generated composite function in association with the generated metadata in the code datastore. The generated composite function may be used for a subsequent program code generation.

In some instances, instead of providing the sequence of steps (of the natural language step-by-step process) directly to the LLM, the natural language-based code generation agent may analyze the sequence of steps against the function availability of the code datastore to determine whether there is a composite function available in the code datastore that performs the functionalities of at least two steps (e.g., consecutive steps) in the sequence of steps. The analysis may be based on the metadata of the respective composite functions (e.g., the textual description of the functionalities of the respective functions). If there is a composite function available in the code datastore that performs the functionalities of the at least two steps (e.g., consecutive steps) in the sequence of steps, the natural language-based code generation agent may combine the at least two steps into a single step to generate a shortened sequence of steps. Subsequently, the natural language-based code generation agent may initiate an LLM to generate program code for the shortened sequence of steps based on the code datastore. The shortened sequence of steps can provide a more efficient use of the LLM (as there may be less function call interfaces to be constructed by the LLM with the shortened interface, and thus the cost associated with the usage of the LLM may be lower).

In some instances, the natural language-based code generation agent may utilize an LLM to analyze the sequence of steps to determine the availability of composite functions in the code datastore (e.g., to shorten the sequence of steps). In some instances, the natural language-based code generation agent may utilize the same LLM for determining a composite function availability and for generating program code. In other instances, the natural language-based code generation agent may utilize a less robust (or lower cost in terms of computational resources, memory resources, etc.) LLM for determining a composite function availability and a more robust (or higher cost in terms of computational resources, memory resources, etc.) LLM for generating program code.

In another embodiment, the input prompt may include a natural language target program code result (without the individual steps to accomplish the target program code result). Continuing with the above Spanish translation example, the natural language-based code generation agent may receive an input prompt stating “Convert file to Spanish PDF”. In this case (and assuming the composite function to convert a text file to a Spanish PDF document hasn't yet been stored in the code datastore), the code generation may include a two-step process. In the first step, the natural language-based code generation agent may determine, based on the functions available in the code datastore, a sequence of steps to accomplish the natural language target program code result. For instance, the natural language-based code generation agent may provide, to an LLM, the natural language statement and the code datastore (e.g., the building blocks or functions) that are available and ask the LLM to output a step-by-step natural language process or algorithm (to accomplish the natural language target program code result). In the second step, the natural language-based code generation agent may provide the step-by-step natural language process and the code datastore (with the annotated functions) to the LLM and the LLM may output the program code for accomplishing the target program code result. In some instances, the natural language-based code generation agent may utilize a less robust (or lower cost in terms of computational resources, memory resources, etc.) LLM to determine the sequence of steps and a more robust (or higher cost in terms of computational resources, memory resources, etc.) LLM to generate the program code.

To improve efficiency, the determination of the sequence of steps for accomplishing the natural language target program code result may prioritize composite functions over base-level functions. Continuing with the above Spanish translation example, if there is a composite function in the code datastore that converts a text file to Spanish PDF document, the natural language-based code generation agent may provide the natural language target program code result in the input prompt directly to the LLM and initiate the LLM to generate program code for the natural language target program code result using the code datastore. Similar to the natural language step-by-step process input example discussed above, the natural language-based code generation agent may utilize the code programming and testing tools to evaluate the accuracy and/or efficiency of the LLM generated program code for the target program code result and iterate through one or more LLM iterations. Further, the natural language-based code generation agent may analyze the LLM generated program code for the target program code result to determine whether there are any composite functions to be created and stored in the code datastore (e.g., after the evaluation of the LLM generated code indicates a pass).

In embodiments, the natural language-based code generation agent may perform code datastore maintenance to improve the performance (e.g., efficiency) of the code datastore. For instance, the code datastore may include multiple functions (e.g., a first function and a second function) performing the same functionality but include different code instructions. This may occur under various situations. In a first example, the first function may be generated as part of a first task (e.g., a project, a workflow, an application) and the second function may be generated as part of a second task different than the first task. In some instances, the generation of the second function for the second task may be based on a failure of the second task when the first function is being used for the second task. In a second example, the first function may be generated by a first LLM and the second function may be generated by a second LLM different than the first LLM (e.g., in terms of LLM model types and/or LLM versions). For instance, the first function may be generated using ChatGPT-3 and the second function may be generated using ChatGPT-4. That is, a new function with the same functionality as an existing function in the code datastore may be generated proactively based on a different model such as for example when a newer model type or a new version of an existing model type becomes available.

As part of the code datastore maintenance, the natural language-based code generation agent may periodically evaluate functions (e.g., the first function and the second function with the same functionality but different code instructions) in the code datastore. For instance, the evaluation may include a comparison of respective metadata of the first function and the second function. For instance, the comparison may be based on a processing resource utilization of the respective function, a memory resource utilization of the respective function, a model type of an LLM that generated the respective function, a model version of an LLM that generated the respective function, a number of successes associated with the respective function, a number of failures associated with the respective function, a number of invocations of the respective function, and/or a weighting value associated with the respective function.

After evaluating the first function and the second function, the natural language-based code generation agent may update the code datastore based on the evaluation. For instance, the natural language-based code generation agent may remove a less efficient or lower performance (e.g., in terms of runtime cycle count, memory usage, and/or error count or the one created by a lower performance or less robust LLM) one of the first function or the second function from the code datastore. Alternatively, the natural language-based code generation agent may set a higher weighting for the more efficient or higher performance one of the first function or the second function (e.g., in respective metadata) and a lower weighting for the other one of the first function or the second function (e.g., in respective metadata).

In a further embodiment, as part of the code datastore maintenance, the natural language-based code generation agent may periodically (or based on a random function) generate an alternate function code set (even when one or more functions with the same functionality are already in the code datastore) for improvement analysis. As discussed above, in some instances, a first function may perform well for a first task (or context) but may not perform well (or even fail) when used for a second task (or context), and a second function that performs the same functionality as the first function but with different instruction codes may perform well for the second task. This may happen in a variety of situations. In one example, the first function may have a certain response time that may be sufficient for the first task but not for the second task (which may have a stringent response time requirement). In another example, the first function may invoke a certain LLM with a performance that may be sufficient for the first task but not for the second task (which may need an LLM with a different strength due to the different task context). Thus, it may be beneficial for the code datastore to keep both the first and second functions so that a selection between the two functions can be made during code generation based on the intended task context. In such an embodiment, the natural language-based code generation agent may set the weighting for the functions in the code database further based on the history of use and task contexts. That is, the weighting for the functions can be context-based weightings in addition to the performance-based weighting discussed above. The result of the improvement analysis may mean that the code database may have multiple functions with the same functionality but different instruction codes, where the natural language-based code generation agent can randomly select a function in the code database for analysis, generate one or more alternate functions, and include those alternate functions in the code datastore.

Providing a custom AI-driven program code generation framework can enable customized, purpose-built LLM-based automations (e.g., workflow automations) to operate on local resources (e.g., files, software, and/or hardware on local computers of an individual or organization). Executing the custom AI-driven program code generation software on a local machine and having the code datastore stored locally can provide data privacy and security. Utilizing a specific code datastore for program code generation can allow an individual or an organization to have full control of programming logic in building functional blocks (e.g., base-level functions) for program code generation. Including composite functions in the code datastore allows for complex software codes to be used as building blocks for program code generation, allowing for complex applications (e.g., automations). Prioritizing use of composite functions over base-level functions in the process of program code generation can provide more efficient use of the LLM (as there may be cost associated with the usage of the LLM). Utilizing multiple LLM iterations and LLM iteration evaluation (e.g., integrating compiler tests, functional tests, code violation checks, and/or runtime efficiency checks) can ensure the accuracy of LLM generated program code. Periodically evaluating functions in the code datastore and updating the functions code datastore based on the evaluations can improve the efficiency and/or accuracy of the functions in the code datastore and ensure that the performance of the functions in the code datastore can continue to improve as newer LLM technologies are available. Further, the custom AI-driven program code generation framework enables non-technical users to write program code (e.g., to automate workflows).

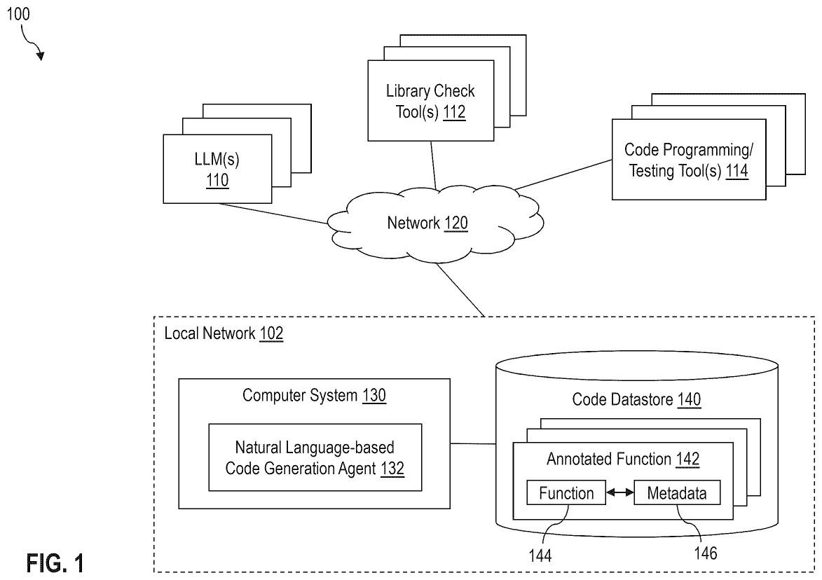

Turning now to FIG. 1, a network system 100 that provides efficient, customizable AI-driven code generation from natural language input prompts using LLMs is described. The system 100 may include LLMs 110, library check tools 112, code programming and testing tools 114, a network 120, a computer system 130, and a code datastore 140. The network 120 promotes communication between the components of the network system 100. The network 120 may be any communication network including a public data network (PDN), a public switched telephone network (PSTN), a private network, and/or a combination.

To ensure data privacy and security, the computer system 130 may be a local machine or server in a local network 102 of an individual or organization and the code datastore 140 may also be within the local network 102. In some instances, the computer system 130 may be coupled to the code datastore 140 via a network interface. In other instances, the computer system 130 may be directly connected to a storage device hosting the code datastore 140. For example, the code database 140 may be stored in an external hard drive connected to the computer system 130 via a universal serial bus (USB) interface. Alternatively, the code datastore 140 may be stored in the local memory of the computer system 130.

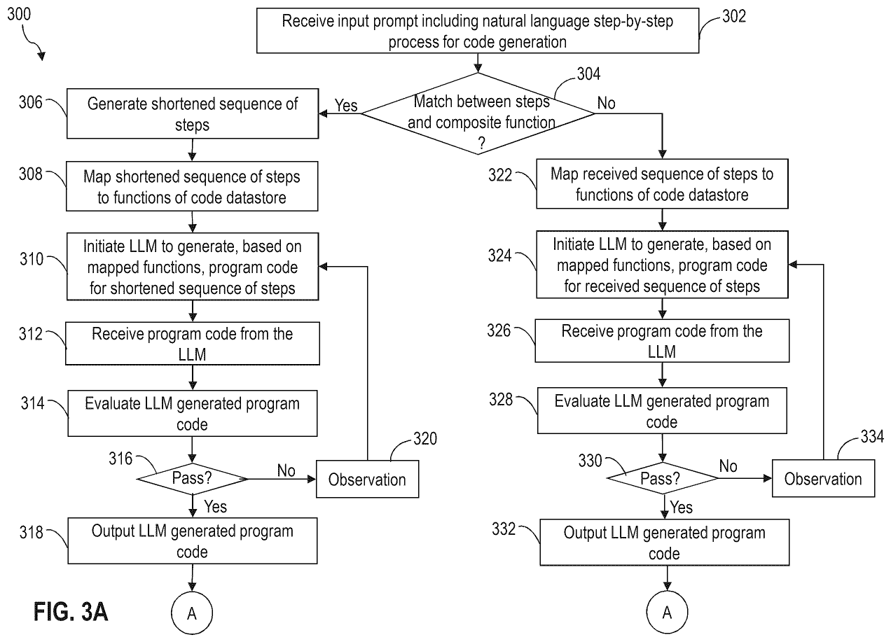

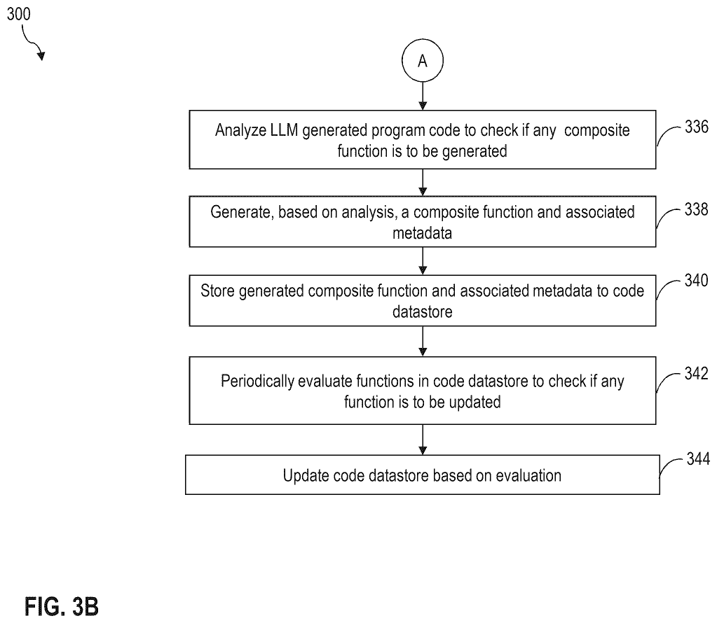

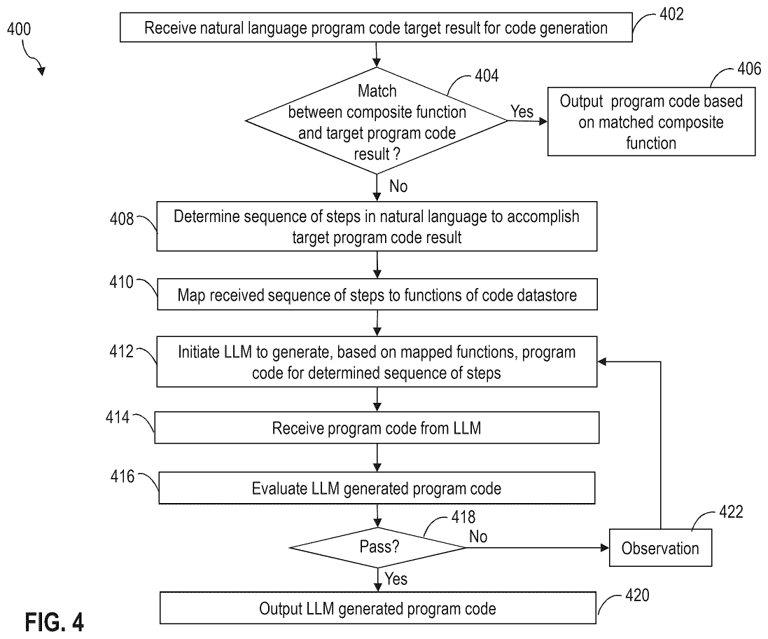

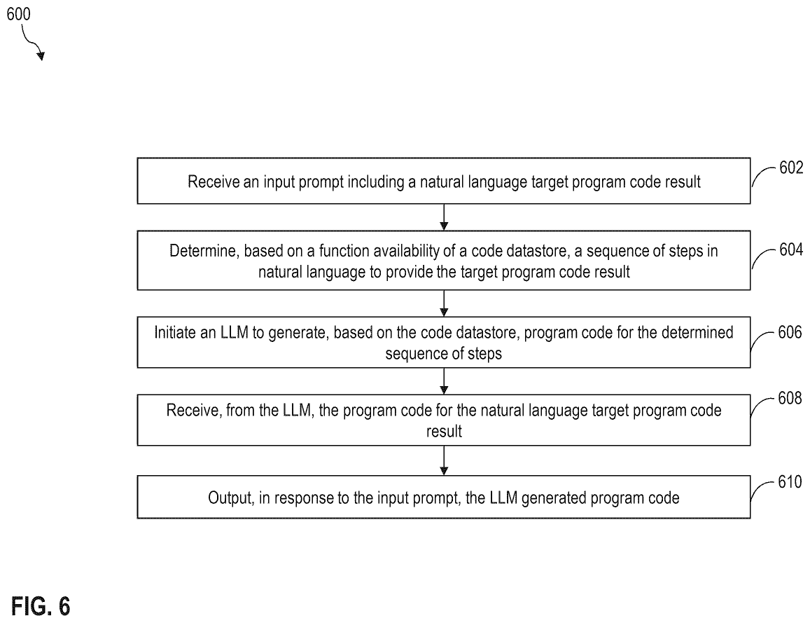

The computer system 130 may include at least one non-transitory memory and at least one processor. The computer system 130 may include a natural language-based code generation agent 132 (e.g., a Microsoft Windows application, an Apple MAC application, a Linux application, etc.) including instructions stored in the memory and executable by the processor. At a high level, the natural language-based code generation agent 132 may receive an input prompt in natural language providing instruction(s) for generating program code to accomplish a certain task or to solve a certain problem. In one embodiment, the input prompt may include a natural language step-by-step process (e.g., a natural language algorithm) including a sequence of steps to accomplish the task as will be discussed more fully below with reference to FIGS. 3A-3B and 4-5. In another embodiment, the input prompt may include a natural language target program code result of the task (without the individual steps for accomplishing the task) as will be discussed more fully below with reference to FIGS. 4 and 6. The task may be associated with any suitable application or services, such as authentication services, anti-counterfeiting services, brand protection services, customer service chatbots, research summarization, medical diagnostics, financial analysis, etc. In some instances, the task may be associated with an automation of a certain workflow. In some instances, the automation may be LLM-based automation. In response to the input prompt, the natural language-based code generation agent 132 may invoke one or more LLMs 110 to generate the program code for accomplishing the certain task using the code datastore 140 and output the LLM generated program code.

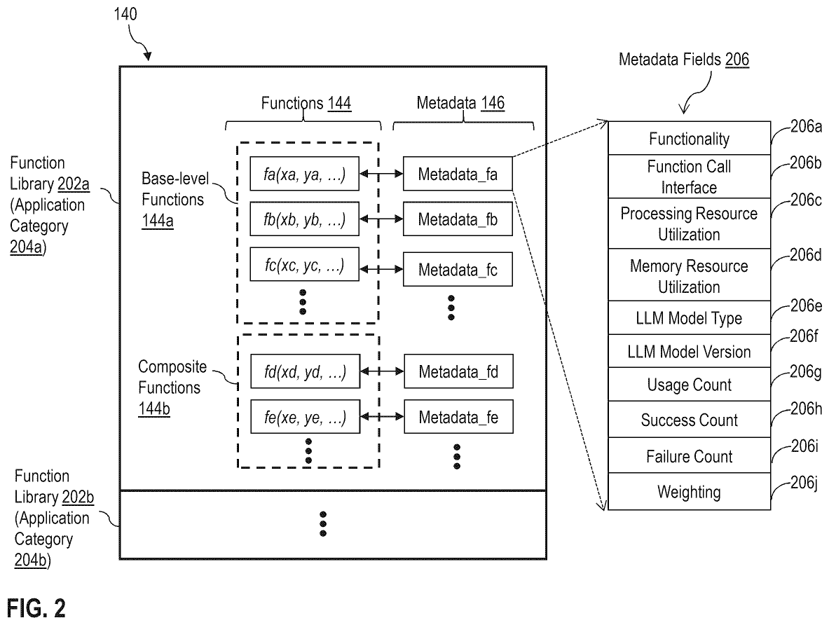

The code datastore 140 may include annotated functions 142 (e.g., multiple functions 144, each in association with respective metadata 146), which are the building blocks for generating program code. The functions 144 may include program code of a certain programming and/or scripting language (e.g., Python, JavaScript, C, C++, etc.). In a certain example, the functions 144 are Python scripts. The functions 144 of the code datastore 140 may include base-level functions and composite functions as shown in FIG. 2. As discussed above, a base-level function may refer to a function that performs a single specific task without invoking another base-level function, and a composite function may refer to a function that invokes at least two base-level functions and may include conditional calls to the base-level functions.

Turning now to FIG. 2, an example of the code datastore 140 is described. As shown in FIG. 2, the code datastore 140 may include a plurality of functions 144. The plurality of functions 144 may include base-level functions 144a (e.g., fa, fb, fc, . . . ) and composite functions 144b (e.g., fd, fe, . . . ). As an example (e.g., using the Spanish translation example discussed above), the base-level function 144a fa may include code instructions for reading a text file, the base-level function 144a fb may include code instructions for converting a text file to Spanish, and the base-level function 144a fc may include code instructions for outputting a Spanish text file as a PDF document. As a further example, the composite function 144b fd may include code instructions for converting a text file to a Spanish PDF document and may invoke the base-level functions 144a fa, fb, and fc in order. While FIG. 2 illustrates the functions 144 fa, fb, fc, fd, and fe, each with two or more function arguments, a function can include any suitable number of arguments (e.g., 0, 1, 2, 3, 4, 5, 6 or more).

As further shown in FIG. 2, each function 144 may be stored in association with respective metadata 146. For instance, the base-level function 144a fa is stored in association with metadata 146 represented by Metadata_fa, the base-level function 144a fb is stored in association with metadata 146 represented by Metadata_fb, and so on. Each metadata 146 may include a variety of information associated with the usage, the creation, and/or the execution of the respective function 144. For instance, each metadata 146 may include a plurality of metadata fields 206. For ease of illustration, FIG. 2 only shows the metadata fields 206 for the metadata 146 of the base-level function 144a fa. For instance, the metadata 146 may include a metadata field 206a including a textual description of a functionality (or a behavior) of the respective function 144. As an example, the base-level function 144a fa may read a text file, and thus the respective metadata field 206a may include a statement: “Functionality: Read a text file”. Additionally or alternatively, the metadata 146 may include a metadata field 206b including a text description of a function interface call (e.g., how to call the function) of the respective function 144. Continuing with the read text file example, the metadata field 206b for the base-level function 144a fa may include a statement: “Input arguments: xa and ya, where xa is a storage location and filename of an input text file (e.g., c:/xyz/filename.txt) and ya is a return handle or pointer referencing the read text file.”

Additionally or alternatively, the metadata 146 may include a metadata field 206c indicating a runtime processing resource utilization of the respective function 144. In an example, the metadata field 206c may indicate a number of instruction cycles for executing the respective function 144. Additionally or alternatively, the metadata 146 may include a metadata field 206d indicating a runtime memory resource utilization of the respective function 144. In an example, the metadata field 206d may indicate a number of bytes for storing local and/or global variables of the respective function 144.

Additionally or alternatively, the metadata 146 may include metadata fields 206e and/or 206f associated with the creation of the respective function 144. The metadata field 206e may indicate an LLM model type (e.g., OpenAI® models such as ChatGPT) used for creating the respective function 144. The metadata field 206f may indicate an LLM model version (e.g., ChatGPT-3, ChatGPT-3.5, ChatGPT-4, ChatCPT-4 turbo etc.) of the certain LLM model type used for creating the respective function 144.

Additionally or alternatively, the metadata 146 may include metadata fields 206g, 206h, and 206i associated with execution or performance of the respective function 144. The metadata field 206g may include a usage count indicating the number of times the respective function 144 has been invoked by a caller function (e.g., LLM generated program code). The metadata field 206h may include a success count indicating the number of times the respective function 144 has been invoked with a successful result for the caller function. The metadata field 206i may include a failure count indicating the number of times the respective function 144 has been invoked with a failure result for the caller function. As will be discussed more fully below with reference to FIGS. 3A-3B, the natural language-based code generation agent 132 may update the metadata fields 206g, 206h, and 206i over time based on executions of program codes that invoke the respective function 144.

Additionally or alternatively, the metadata 146 may include metadata fields 206j indicating a weighting. As will be discussed more fully below, in some instances, the code datastore 140 includes multiple functions 144 with the same functionality but different code instructions. In such instances, a weighting value may be assigned to each of those functions 144 (with the same functionality) based on their relative performance or efficiency.

In some instances, the code datastore 140 may organize the functions 144 along with respective metadata 146 into function libraries 202 according to application categories 204. Some examples of application categories 204 may include, but are not limited to, text processing, audio processing, image processing, video processing, authentication, anti-counterfeiting, brand protection, text processing applications (e.g., code generation, code critique, brainstorming for idea generation, business plan critique, etc.). In the illustrated example of FIG. 2, the code datastore 140 includes a function library 202a and a function library 202b. The function library 202a may include functions 144 specific to an application category 204a. The function library 202b may include functions 144 specific to an application category 204b different than the application category 204a.

FIG. 2 is merely an example of components of a code datastore, and variations are contemplated to be within the scope of the present disclosure. In embodiments, the code datastore 140 may include other components not illustrated in FIG. 2. In embodiments, the code datastore 140 may not include every component illustrated in FIG. 2. For instance, some metadata fields 206 may be optional for some functions 144. In other instances, some functions 144 may include additional metadata fields. In embodiments, the components of the code datastore may be arranged differently than those illustrated in FIG. 2. Such and other embodiments are contemplated to be within the scope of the present disclosure.

Returning to FIG. 1, the LLMs 110 may be of different LLM types having different attributes. For instance, the LLMs 110 may include, but are not limited to, one or more OpenAI® models (e.g., a GPT-3 model, a GPT-3.5 model, a GPT-4 model), one or more open-source LLMs, an LLM Meta AI (Llama) model, a Google Gemini® model, and Claude family of models from Anthropic). The different LLMs 110 may have different performances, robustness, or strengths (e.g., for summarization, deep reasoning, code constructions, etc.). For instance, the different LLMs 110 may have different transformer architectures and may be trained on different types of datasets (e.g., from different technical fields and in various data modes, such as audio, video, and/or texts) and/or different amounts of data. As will be discussed more fully below with reference to FIGS. 3A-3B and 4-8, the natural language-based code generation agent 132 may invoke various LLMs 110 at different stages of program code generations. Depending on the complexity of the particular stage, the natural language-based code generation agent 132 may utilize a less robust LLM 110 (with a lower performance) for a less complex task (e.g., analysis of natural language step-by-step process, determining steps to accomplish target program code result, etc.) and a more robust LLM 110 (with a higher performance) for a more complex task (e.g., generating program code, etc.). The different LLMs 110 may also have different associated costs. For instance, the different LLMs 110 may utilize different amounts of computational resources and/or memory resources. Additionally or alternatively, the different LLMs 110 may be associated with different subscription or service costs (e.g., each call to an OpenAI LLM incurs a fee). Generally, the higher the performance of the LLM 110, the higher the cost.

The library check tools 112 may include software tools for analyzing functionalities of functions 144 and/or program codes and/or interactions among functions 144 against a set of rules or metrics (e.g., for determining whether a composite function 144b is to be generated as will be discussed below). In some instances, the library check tools 112 may utilize one or more of the LLMs 110 for the analysis.

The code programming and test tools 114 may include tools for compiling and/or testing program code. For instance, the code programming and test tools 114 may include programming-language specific compilers (e.g., a Python compiler, a JavaScript compiler, a C/C++ compiler, etc.). The code programming and test tools 114 may also include functional testing tools (e.g., Microsoft Visual Studio), which may include simulators for executing program code and/or debuggers for debugging program code. In some instances, the code programming and test tools 114 may also include automation testing scripts, for example, to test a function 144 under various conditions or for various test cases.

In an embodiment, the natural language-based code generation agent 132 may initiate multiple LLM iterations to generate certain program code from a natural language input prompt (e.g., including a natural language step-by-step process or a natural language target program code result). At each LLM iteration, the natural language-based code generation agent 132 may evaluate respective program code generated by an LLM 110 using the code programming and test tools 114. The natural language-based code generation agent 132 may determine, based on the evaluation, whether an LLM generated program code satisfies one or more criteria (e.g., associated with compilation of the code, functionalities of the code, and various checks for constraints, such as runtime efficiency and/or code violation). The natural language-based code generation agent 132 may iterate through one or more LLM iterations until the LLM 110 outputs program code that satisfies the one or more criteria. In some instances, different LLM iterations may utilize different LLMs 110 (with different model attributes, different performances, etc.). Mechanisms for utilizing multiple LLM iterations with LLM iteration evaluation will be discussed more fully below with reference to FIGS. 3A-3B and 4-7. The use of multiple LLM iterations with LLM iteration evaluation can improve the accuracy and/or efficiency of the LLM generated program code.

In an embodiment, after generating program code for a natural language input prompt (e.g., including a natural language step-by-step process or a natural language target program code result), the natural language-based code generation agent 132 may analyze the LLM generated program code and check for composite functions 144b to be created and stored in the code datastore 140 using the library check tools 112 as will be discussed more fully below with reference to FIGS. 3A-3B and 4-7. Creating and storing composite functions 144b in the code datastore 140 can enable more efficient use of the LLMs 110 in subsequent program code generations. For instance, when the natural language-based code generation agent 132 receives a subsequent input prompt for code generation, the natural language-based code generation agent 132 may generate program code by prioritizing the use of composite functions 144b over the use of base-level function 144a as will be discussed more fully below with reference to FIGS. 3A-3B and 4-6.

FIG. 1 is merely an example of components of a network system, and variations are contemplated to be within the scope of the present disclosure. In embodiments, the network system may include other components not illustrated in FIG. 1. In embodiments, the network system may not include every component illustrated in FIG. 1. In embodiments, the components of the network system may be arranged differently than those illustrated in FIG. 1. For example, in some instances, one or more of the LLMs 110, one or more of the library check tools 112, and/or one or more of the code programming and testing tools 114 may be within the local network 102. In other embodiments, the natural language-based code generation agent 132 may not execute locally on the computer system 130 within the local network 102 and/or the code datastore 140 may not be stored locally within the local network 102, and such embodiments may still deliver efficiencies (e.g., composite function creations, use of multiple LLM iterations and LLM iteration evaluation, etc.) discussed below. Such and other embodiments are contemplated to be within the scope of the present disclosure.

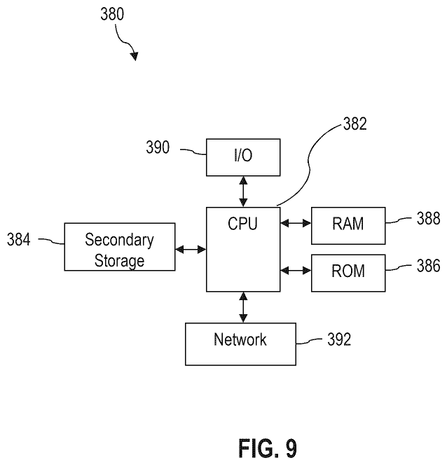

Turning now to FIGS. 3A and 3B, an example method 300 for providing AI-driven code generation from a natural language step-by-step process is described. The method 300 may include similar mechanisms as discussed above with reference to FIGS. 1-2. The method 300 may be implemented by the natural language-based code generation agent 132. In embodiments, the method 300 may be implemented using a computer system with components as shown in FIG. 9. As illustrated, FIGS. 3A and 3B include a number of enumerated operations, but embodiments of the operations in FIGS. 3A and 3B may include additional operations before, after, and in between the enumerated operations. In some embodiments, one or more of the enumerated operations may be omitted or performed in a different order.

At block 302, the natural language-based code generation agent 132 receives an input prompt including a natural language step-by-step process (e.g., a natural language algorithm) for code generation. The natural language step-by-step process includes a sequence of steps for accomplishing a specific task. As an example, the task may be to convert a text file (e.g., in English) to a Spanish PDF document, and the input prompt may include a first step to read a text file, a second step to convert the text file to Spanish, and a third step to output the Spanish translated text in a PDF document. In some instances, the input prompt may be received from a user interface (UI) provided by the natural language-based code generation agent 132.

At block 304, upon receiving the input prompt, the natural language-based code generator agent 132 determines whether there is a match between two or more steps (e.g., consecutive steps) in the sequence of steps and a composite function 144b in the code datastore 140. The determination may include parsing and interpreting each step in the sequence and the metadata 146 of the code datastore 140 to search for a composite function 144b with a functionality (e.g., in a corresponding metadata field 206a) that matches two or more steps in the sequence. If the natural language-based code generation agent 132 determines that there is a match between at least two of the steps in the sequence and a composite function 144b, the natural language-based code generation agent proceeds to block 306.

At block 306, the natural language-based code generation agent 132 generates, based on the match, a shortened sequence of steps by combining the at least two steps into a single step. In some instances, the composite function 144b may implement less than all steps in the sequence of steps. In other instances, the composite function 144b may implement all steps in the sequence of steps. In some instances, there may be multiple matched composite functions 144b, each corresponding to a different subset of two or more steps (e.g., consecutive steps) in the sequence. In such instances, the natural language-based code generation agent 132 may combine respective steps that are mapped to each matched composite function 144b. As an example, the sequence may include five steps: step 1, step 2, step 3, step 4, and step 5, one composite function 144b (in the code datastore 140) may match operations of steps 2 and 3, and another composite function 144b (in the code datastore 140) may match operations of steps 4 and 5. Thus, the natural language-based code generation agent may combine steps 2 and 3 into a single step and combine steps 4 and 5 into another single step to generate a shortened sequence including three steps.

At block 308, the natural language-based code generation agent 132 maps the shortened sequence of steps to corresponding functions 144 of the code datastore 140. The mapping may include interpreting each step in the shortened sequence and the metadata 146 of the code datastore 140 to search for a function 144 with a functionality (e.g., in a corresponding metadata field 206a) that matches the operations of the respective step. The mapped functions 144 may include the composite function 144b (that matches the at least two steps in the received sequence of steps) identified at block 304.

At block 310, the natural language-based code generation agent 132 initiates an LLM 110 to generate, based on the mapped functions 144 of the code datastore 140, program code for the shortened sequence of steps. As part of the initiation, the natural language-based code generation agent 132 may provide the shortened sequence of steps, a reference to the code datastore 140 and an indication of the mapped functions 144 as input to the LLM 110. The reference may be a handle or a pointer to a storage location of the code datastore 140. In response to the initiation, the LLM 110 may construct the program code by including the mapped functions 144 (e.g., a subset of the plurality functions 144 of the code datastore 140). As part of constructing the program code, the LLM 110 may interpret the metadata 146 in the code datastore 140 to construct the function calls with input and/or output parameters according to the respective metadata 146 (or more specifically, the function call interfaces in the respective metadata fields 206b) of the mapped functions 144. At block 312, the natural language-based code generation agent 132 receives the program code from the LLM 110.

At block 314, the natural language-based code generation agent 132 evaluates the LLM generated program code, for example, using the code programming and testing tools 114. The natural language-based code generation agent 132 may determine whether the LLM generated program code satisfies one or more criteria based on the evaluation. The one or more criteria may include at least one of a compiler test with no error, functional tests with no error, a runtime efficiency threshold being satisfied, or no detected code violation. Thus, as part of the evaluation, a set of tests (e.g., a compiler test, a functional test, etc.) and/or a set of constraints (e.g., related to runtime efficiency, code violation, etc.) may be applied to the LLM generated program code.

To perform a compiler test, the natural language-based code generation agent 132 may initiate a compiler tool (e.g., one of the code programming and testing tools 114) to compile the LLM generated program code. If the compiler returns no error, the compiler test is successful. If, however, the compiler returns an error, the compiler test fails.

To perform a functional test, the natural language-based code generation agent 132 may initiate a functional testing tool (e.g., the code programming and testing tools 114) to test a functionality of the LLM generated program code against a set of predetermined test cases. Each predetermined test case may specify input to the program code under test and the expected output from the program code under test (or an expected score for the output of the program code under test). For instance, a functional test may provide the input specified in a test case to the program code under test, execute the program code, and compare the output of the program code under test (from execution) to the expected output or expected score specified in the test case. As an example, a function 144 is an image classification function, and the corresponding test cases may include various input images of different objects, each with an expected classification output (e.g., in terms of a score) corresponding to the respective object. If the functional testing tool returns no error for all the test cases (e.g., the LLM generated code outputs from all the test cases are as expected), the functional test is successful. If, however, an error or a failure occurs for any one of the test cases (e.g., the LLM generated code outputs from one or more of the test cases are not as expected), the functional test fails.

To test for runtime efficiency, the natural language-based code generation agent 132 may obtain an indication of a processing resource utilization (e.g., in terms of a number of instruction cycles) and/or a memory resource utilization (e.g., in terms of a number of bytes used for storing global and/or local variables and/or a stack) measured during runtime (e.g., while a functional test is being executed). The natural language-based code generation agent 132 may determine whether the runtime efficiency satisfies a certain threshold (e.g., a threshold number of instruction cycles for processor usage or a threshold number of bytes for memory usage).

To test for code violation, the natural language-based code generation agent 132 may inspect and analyze the LLM generated code to determine whether the LLM generated code includes functions 144 outside of a list of predetermined allowable functions 144. Other examples of code violations may be based on a set of predetermined coding rules (e.g., not to include infinite loops, deeply nested functions that are more than a threshold number of levels deep, etc.).

At block 316, the natural language-based code generation agent 132 determines whether the evaluation at block 314 is a pass. The evaluation is a pass if the LLM generated code satisfies the one or more criteria. If the natural language-based code generation agent 132 determines that the evaluation of the LLM generated code is a pass, the natural language-based code generation agent 132 proceeds to 318. At block 318, the natural language-based code generation agent 132 outputs the LLM generated code in response to the input prompt received at block 302. Continuing with the above Spanish translation example, the code datastore 140 may include a read text file function 144 that reads a text file, a Spanish translation function 144 (e.g., from English to Spanish), and a write PDF document function 144, and the LLM generated program code may include the three individual functions 144 (the read text file function 144, the Spanish translation function 144, and the write PDF document function 144). The LLM generated program code may further include a main program that invokes the three individual functions 144 in the order of the sequence of steps.

If, however, the natural language-based code generation agent 132 determines that the evaluation of the LLM generated code fails to satisfy the one or more criteria, the natural language-based code generation agent 132 proceeds to block 320. At block 320, the natural language-based code generation agent 132 makes observation (e.g., error(s) or failure(s) from the evaluation) and returns to block 310 to reinitiate the LLM 110 to generate program code for the shortened sequence of steps using the code datastore 140. As part of the reinitiation, the natural language-based code generation agent 132 may provide, to the LLM 110, feedback from the evaluation (e.g., obtained from the observations at block 320) in addition to the shortened sequence of steps and the reference to the code datastore 140.

As an example, if an error is detected from the compilation of the LLM generated program code, the feedback may include a compiler error message. As another example, if an error is detected from a functional test of the LLM generated program code, the feedback may include a functional test error and/or a potential reason that causes the error (e.g., determined based on the observation at block 320). As yet another example, if an error is detected from a runtime efficiency test of the LLM generated program code, the feedback may indicate a runtime efficiency error and an expected runtime efficiency or threshold. As a further example, if an error is detected from a code violation test of the LLM generated program code, the feedback may indicate the function(s) 144 and/or operation(s) that are in violation. For instance, the feedback may indicate the function(s) 144 that are outside of the predetermined list of functions 144 and/or the operation(s) that violated a certain coding rule.

In some instances, the natural language-based code generation agent 132 may utilize a second LLM 110 to map the shortened sequence of steps to the corresponding functions 144 of the code datastore 140 at block 308. In some instances, the second LLM 110 may be the same as the LLM 110 initiated for generating the program code at block 310. In other instances, the second LLM 110 may be different than the LLM 110 initiated for generating the program code at block 310. In an example, the natural language-based code generation agent 132 may utilize a less robust (or lower cost) LLM 110 for mapping the shortened sequence of steps to the corresponding functions 144 and a more robust (or higher cost) LLM 110 for generating the program code. Generally, the less robust LLM 110 and the more robust LLM 110 may include different model attributes (e.g., different LLM model types, different versions of a particular LLM model, different transformer architectures, trained on different types of data and/or different amounts of data, etc.).

In some instances, the natural language-based code generation agent 132 may utilize a different LLM 110 when reinitiating the LLM process after block 320. For instance, the natural language-based code generation agent 132 may initially utilize a less robust (or lower cost) LLM 110 to generate the program code and may switch to utilize a more robust (or higher cost) LLM 110 to generate the program code after a certain number of failures (e.g., 1, 2, 3 or more) or re-initiations (e.g., 1, 2, 3 or more) have occurred. In some instances, the natural language-based code generation agent 132 may further update the execution or performance related information (e.g., the usage/success/failure counters in respective metadata fields 206g, 206h, and 206i) in the metadata 146 of the code datastore 140 for the respective functions 144 invoked in the LLM generated code based on the evaluation at block 314.

Next, at block 336, after outputting the LLM generated code (that passes the evaluation), the natural language-based code generation agent 132 analyzes the LLM generated code to check if any composite function 144b is to be generated, for example, using the library check tools 112. Referring to the Spanish translation example discussed above, the natural language-based code generator agent 132 may generate a composite function 144b for converting a text file to a Spanish PDF document made up of the three individual functions 144 (the read text file function 144, the Spanish translation function 144, and the write PDF document function 144) of the code datastore 140. More specifically, the composite function 144b may invoke the read text file function 144, the Spanish translation function 144, and the write PDF document function 144 in the same order as the sequence of steps. The determination of whether there are any composite functions 144b to be created and stored in the code datastore 140 may be based on a set of rules (e.g., whether a combination of two or more functions 144 perform a meaningful or useful task, whether a combination of the two or more functions 144 may improve processing and/or memory utilization efficiency, a frequency of occurrences of the two or more functions 144 being invoked consecutively across a number of software programs exceeding a certain threshold, etc.).

At block 338, after the composite function 144b is generated, the natural language-based code generation agent 132 generates metadata 146 for the composite function 144b. The generated metadata 146 may include a textual description of functionality (e.g., a metadata field 206a) and/or a function call interface (e.g., a metadata field 206b) of the generated composite function 144b, the LLM model type (e.g., a metadata field 206e) and/or LLM model version (e.g., a metadata field 206f) used for generating the composite function 144b. The generated metadata 146 may also include a processing resource utilization (e.g., a metadata field 206c) and a memory resource utilization (e.g., a metadata field 206d) of the generated composite function 144b. The natural language-based code generation agent 132 may also set (or initialize) the usage count (e.g., a metadata field 206g), the success count (e.g., a metadata field 206h), and the failure count (e.g., a metadata field 206i) in the generated metadata 146 to values of zero. The natural language-based code generation agent 132 may also set (or initialize) the weighting (e.g., a metadata field 206j) in the generated metadata 146 to a value of one (as this may be the first instance of the composite function 144b in the code datastore 140). At block 340, after generating metadata 146 for the composite function 144b, the natural language-based code generation agent 132 may store the generated composite function 144b in association with the generated metadata 146 in the code datastore 140.

At block 342, the natural language-based code generation agent 132 periodically evaluates the functions 144 in the code datastore 140 to check if any function 144 in the code datastore 140 is to be updated. For instance, the code datastore 140 may include multiple functions 144 (e.g., a first function 144 and a second function 144) performing the same functionality. This may occur under various situations. In an example, the first function 144 may be generated as part of a first task (e.g., a project, a workflow, an application) and the second function 144 may be generated as part of a second task different than the first task. In some instances, the generation of the second function 144 for the second task may be based on a failure of the second task when the first function 144 is being used (or invoked) for the second task. In another example, the first function 144 may be generated by a first LLM 110 and the second function 144 may be generated by a second LLM 110 different than the first LLM 110 (e.g., in terms of LLM model types and/or LLM versions). For instance, the first function 144 may be generated using ChatGPT-3 and the second function 144 may be generated using ChatGPT-4.

At block 344, the natural language-based code generation agent 132 updates the code datastore 140 based on the evaluation at block 342. For instance, after evaluating the first function 144 and the second function 144 (that perform the same functionality), the natural language-based code generation agent 132 may remove a less efficient or lower performance (e.g., in terms of runtime cycle count, memory usage, and/or error count) one of the first function 144 or the second function 144 from the code datastore 140. Alternatively, the natural language-based code generation agent 132 may set a higher weighting value for the more efficient or higher performance one of the first function 144 or the second function 144 (e.g., in a respective metadata field 206j) and a lower weighting value for the other one of the first function 144 or the second function 144 (e.g., in a respective metadata field 206j). In an example, the weighting value may be a value between 0 and 1. Generally, weighting values may be assigned to each function 144 of a subset of functions 144 (with the same functionality) based on their relative performance or efficiency. In an example, for a subsequent program code generation, an LLM 110 may select a function 144 with the higher weighting when multiple functions 144 with the same functionality but different code instructions are available in the code datastore 140.

In some instances, the natural language-based code generation agent 132 may update the code datastore 140 further based on an availability of a new or newer LLM 110 (e.g., a higher performance or more robust LLM model or LLM version). For instance, when a new LLM 110 is available, the natural language-based code generation agent 132 may generate, using the newly available LLM 110, a new function 144 with the same functionality as an existing function 144 and add the new function 144 to the code datastore 140 along with respective metadata 146. Accordingly, the code datastore 140 may continue to improve as newer LLM or AI technologies are available.

Returning to block 304, if the natural language-based code generation agent 132 determines that there is not a match between two or more steps in the sequence of steps (in the input prompt received at block 302) and a composite function 144b in the code datastore 140, the natural language-based code generation agent 132 proceeds to block 322. At block 322, the natural language-based code generation agent 132 maps the received sequence of steps to corresponding functions 144 of the code datastore 140. The operations at block 322 is similar to block 308, except the function mapping is for the received sequence of steps instead of the shortened sequence of steps. Further, the operations at blocks 324, 326, 328, 330, 332, and 334 are similar to the operations at blocks 310, 312, 314, 316, 318, and 320, respectively. Accordingly, for brevity, details of those blocks will not be repeated here. After the natural language-based code generation agent 132 outputs the LLM generated program code at block 332, the natural language-based code generation agent 132 may proceed to perform blocks 336 to 344 to generate composite function(s) 144b and perform maintenance of the code datastore 140 as discussed above.

In some instances, when the LLM 110 is reinitiated to generate program code at block 310 or block 324 due to a failed evaluation, the LLM 110 may select different functions 144 from the code datastore 140 for the respective sequence of steps than the ones that were in the previous generated program code. As discussed above, the code datastore 140 may include multiple functions 144 with the same functionality but different code instructions. Thus, the remapping of steps to functions 144 can map the steps to a sequence of different functions 144.

Turning now to FIG. 4, an example method 400 for providing AI-driven code generation from a natural language target program code result is described. The method 400 may include similar mechanisms as discussed above with reference to FIGS. 1-2 and 3A-3B. The method 400 may be implemented by the natural language-based code generation agent 132. In embodiments, the method 400 may be implemented using a computer system with components as shown in FIG. 9. As illustrated, FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At block 402, the natural language-based code generation agent 132 receives an input prompt including a natural language target program code result (without individual steps to accomplish the target program code result as in the method 300 discussed above) for code generation. As an example, an input prompt may include a statement: “Convert file to Spanish PDF”. In some instances, the input prompt may be received from a UI provided by the natural language-based code generation agent 132.

At block 404, the natural language-based code generation agent 132 determines whether there is a match between the natural language target program code result and a composite function 144b in the code datastore 140. The determination may include parsing and interpreting the natural language target program code result and the metadata 146 of the code datastore 140 to search for a composite function 144b with a functionality (e.g., in a corresponding metadata field 206a) that matches (or provides) the natural language target program code result. If the natural language-based code generation agent 132 determines that there is a match between the natural language target program code result and a composite function 144b, the natural language-based code generation agent proceeds to block 406. At block 406, the natural language-based code generation agent 132 outputs the program code for the natural language target program code result based on the matched composite function 144b.

If, however, the natural language-based code generation agent 132 determines that there is not a match between the natural language target program code result and a composite function 144b, the natural language-based code generation agent 132 proceeds to block 408. At block 408, the natural language-based code generation agent 132 determines a sequence of steps (a step-by-step process) in natural language to accomplish the natural language target program code result based on a function availability of the code datastore 140. Each step may be determined based on a corresponding function 144 being available in the code datastore 140. The determination may prioritize composite functions 144b over the base-level function 144a. In an example, as part of the determination, a step may be determined by first searching for a composite function 144b that may be used to accomplish a part of the natural language target program code result. If there is no suitable composite function 144b for accomplishing at least a part of the natural language target program code result, the search may then proceed to search for a base-level function 144a to accomplish a part of the natural language target program code result. There may be a fewer number of steps when one or more of the steps are mapped to composite function(s) 144b compared to when all steps are mapped to base-level functions 144a.

At block 410, after determining the sequence of steps to accomplish the natural language target program code result, the natural language-based code generation agent 132 maps the determined sequence of steps to corresponding functions 144 of the code datastore 140. At block 412, the natural language-based code generation agent 132 initiates an LLM 110 to generate, based on the mapped functions 144, program code for the determined sequence of steps. As part of the initiation, the natural language-based code generation agent 132 may provide the determined sequence of steps, a reference to the code datastore 140, and an indication of the mapped functions 144 as input to the LLM 110. The LLM 110 may generate the program code using similar mechanisms as discussed above with reference to block 310 of the method 300. Subsequently, the natural language-based code generation agent 132 may receive the LLM generated program code, evaluate the LLM generated program code, and iterate, based on the evaluation, through one or more initiations of the LLM 110 at blocks 412 to 422. The operations at blocks 414, 416, 418, 420, and 422 are similar to the operations at blocks 312, 314, 316, 318, and 320, respectively. Accordingly, for brevity, details of those blocks will not be repeated here. After the natural language-based code generation agent 132 outputs the LLM generated program code at block 420 or the program code based on the matched composite function 144b at block 406, the natural language-based code generation agent 132 may generate composite functions 144b and/or perform maintenance on the code datastore 140 as discussed above with reference to blocks 336 to 344 of the method 300.

In some instances, the natural language-based code generation agent 132 may initiate a second LLM 110 to search for a matched composite function 144b at block 404, determine the sequence of steps at block 408, and/or mapped determined sequence of steps at block 410 to corresponding functions 144. In some instances, the second LLM 110 may be the same as the LLM 110 initiated for generating the program code at block 412. In other instances, the second LLM 110 may be different than the LLM 110 initiated for generating the program code at block 412. For instance, the natural language-based code generation agent 132 may utilize a less robust (or lower cost) LLM 110 for searching for a matched composite function 144b and determining the sequence of steps and a more robust (or higher cost) LLM 110 for generating the program code.

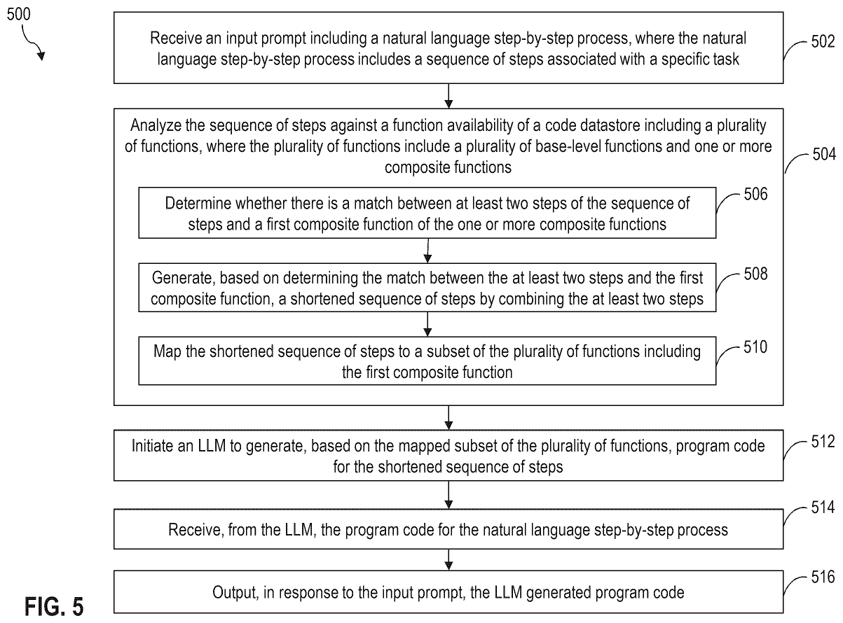

Turning now to FIG. 5, a method 500 is described. In an embodiment, the method 500 is a method for providing efficient, customizable AI-driven code generation from a natural language step-by-step process. The method 500 may include similar mechanisms as discussed above with reference to FIGS. 1-2, 3A-3B, and 4. The method 500 may be implemented by the natural language-based code generation agent 132. In embodiments, the method 500 may be implemented using a computer system with components as shown in FIG. 9. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At block 502, the natural language-based code generation agent 132 receives an input prompt including a natural language step-by-step process. The natural language step-by-step process includes a sequence of steps (individual steps) associated with a specific task. In some instances, the input prompt may be received from a UI provided by the natural language-based code generation agent 132.

At block 504, the natural language-based code generation agent 132 analyzes the sequence of steps against a function availability of a code datastore 140 including a plurality of functions 144. The plurality of functions 144 includes a plurality of base-level functions 144a and one or more composite functions 144b, each invoking at least two of the plurality of base-level functions 144a. The code datastore 140 further includes metadata 146 including a textual description of at least one of a functionality (e.g., the metadata field 206a) or a function call interface (e.g., the metadata field 206b) for each respective one of the plurality of functions 144, and the analyzing the sequence of steps in the natural language step-by-step process against the function availability of the code datastore 140 is further based on the metadata 146. As part of the analyzing, the natural language-based code generation agent 132 may perform operations at blocks 506, 508, and 510. At block 506, the natural language-based code generation agent 132 determines whether there is a match between at least two steps of the sequence of steps and a first composite function 144b of the one or more composite functions 144b. At block 508, the natural language-based code generation agent 132 generates, based on determining the match at block 506, a shortened sequence of steps by combining the at least two steps into a single step. At block 510, the natural language-based code generation agent 132 maps the shortened sequence of steps to a subset of the plurality of functions 144 of the code datastore 140 including the first composite function 144b.

At block 512, the natural language-based code generation agent 132 initiates an LLM 110 to generate, based on the mapped subset of the plurality of functions 144 of the code datastore 140, program code for the shortened sequence of steps. At block 514, the natural language-based code generation agent 132 receives, from the LLM 110, the program code for the natural language step-by-step process. The LLM generated code includes a subset of the plurality of functions 144 of the code datastore 140. At block 516, the natural language-based code generation agent 132 outputs, in response to the input prompt, the LLM generated program code.

In some instances, the analyzing the sequence of steps at block 504 is further based on a second LLM 110. In some instances, the second LLM 110 is different than the LLM 110 initiated for generating the program code for the shortened sequence of steps at block 512. In other instances, the second LLM 110 is the same as the LLM 110 initiated for generating the program code for the shortened sequence of steps at block 512.

In some instances, the natural language-based code generation agent 132 further analyzes, based on one or more criteria, the subset of the plurality of functions 144 in the LLM generated program code to generate a second composite function 144b (a new composite function 144b that is not present in the code datastore 140) that combines at least two functions 144 of the subset of the plurality of functions 144. The natural language-based code generation agent 132 further generates metadata 146 for the second composite function 144b (e.g., as discussed above with reference to block 336 of the method 300). For instance, the generated metadata 146 includes at least a textual description of at least one of a functionality or a function call interface of the second composite function 144b. The natural language-based code generation agent 132 further stores the second composite function 144b in association with the generated metadata 146 in the code datastore 140.

In some instances, the analyzing the subset of the plurality of functions 144 in the LLM generated code to generate the second composite function 144b is further based on a third LLM 110. In such instances, the generated metadata 146 for the second composite function 144b further includes at least one of an LLM model type (e.g., the metadata field 206e) or an LLM model version (e.g., the metadata field 206f) associated with the third LLM 110 that generated the second composite function 144b. In some instances, the second composite function 144b combines all functions 144 of the subset of the functions 144 in the program code for the natural language step-by-step process. In other instances, the second composite function 144b combines less than all functions 144 of the subset of the functions 144 in the program code for the natural language step-by-step process.

In some instances, the input prompt received at block 502 further includes an indication of an application category 204 associated with the natural language step-by-step process, and the code datastore 140 further includes a plurality of function libraries 202, each associated with a different application category 204 and including a set of functions 144. In such instances, the analyzing the sequence of steps at block 504 further includes analyzing the sequence of steps in the natural language step-by-step process against a function availability of a first function library 202 of the plurality of function libraries 202 based on a match between the application category 204 associated with the natural language step-by-step process and an application category 204 associated with the first function library 202, where the plurality of functions 144 correspond to a respective set of functions 144 in the first function library 202.

Turning now to FIG. 6, a method 600 is described. In an embodiment, the method 600 is a method for providing efficient, customizable AI-driven code generation from a natural language target program code result. The method 600 may include similar mechanisms as discussed above with reference to FIGS. 1-2, 3A-3B, and 4-5. The method 600 may be implemented by the natural language-based code generation agent 132. In embodiments, the method 600 may be implemented using a computer system with components as shown in FIG. 9. As illustrated, FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At block 602, the natural language-based code generation agent 132 receives an input prompt including a target program code result in natural language. In some instances, the input prompt may be received from a UI provided by the natural language-based code generation agent 132. At block 604, the natural language-based code generation agent 132 determines, based on a function availability of a code datastore 140, a sequence of steps in natural language to provide the target program code result. The code datastore 140 includes a plurality of functions 144, each in association with metadata 146 including a textual description of at least one of a functionality (e.g., the metadata field 206a) or a function call interface (e.g., the metadata field 206b) of a respective one of the plurality of functions 144. The plurality of functions 144 includes a plurality of base-level functions 144a and one or more composite functions 144b, each invoking at least two of the plurality of base-level functions 144a. In some instances, as part of determining the sequence of steps, the natural language-based code generation agent determines an individual step in the sequence of steps based on a corresponding function 144 being available in the code datastore 140 and a prioritization of the one or more composite functions 144b over the plurality of base-level functions 144a. In some instances, the determining the sequence of steps to provide the target program code result is based on a determination that a function 144 (e.g., a composite function 144b) for providing the target program code result is unavailable in the code datastore 140.

At block 606, the natural language-based code generation agent 132 initiates, an LLM 110 to generate, based on the code datastore 140 and the determined sequence of steps, program code for providing the target program code result. In some instances, the natural language-based code generation agent 132 maps the determined sequence of steps to corresponding functions 144 of the code datastore 140, and the LLM 110 is initiated further to generate the program code based on the mapped functions 144. At block 608, the natural language-based code generation agent 132 receives, from the LLM 110, the program code for providing the target program code result. The LLM generated program code includes a subset of the plurality of functions 144 of the code datastore 140. At block 610, the natural language-based code generation agent 132 outputs, in response to the input prompt, the program code for providing the target program code result.

In some instances, the determining the sequence of steps to provide the target program code result at block 604 is based on a second LLM 110. In some instances, the second LLM 110 for determining the sequence of steps is different than the LLM 110 initiated for generating the program code to provide the target program code result at block 606. In other instances, the second LLM 110 for determining the sequence of steps at block 604 is the same as the LLM 110 initiated for generating the program code to provide the target program code result at block 606.

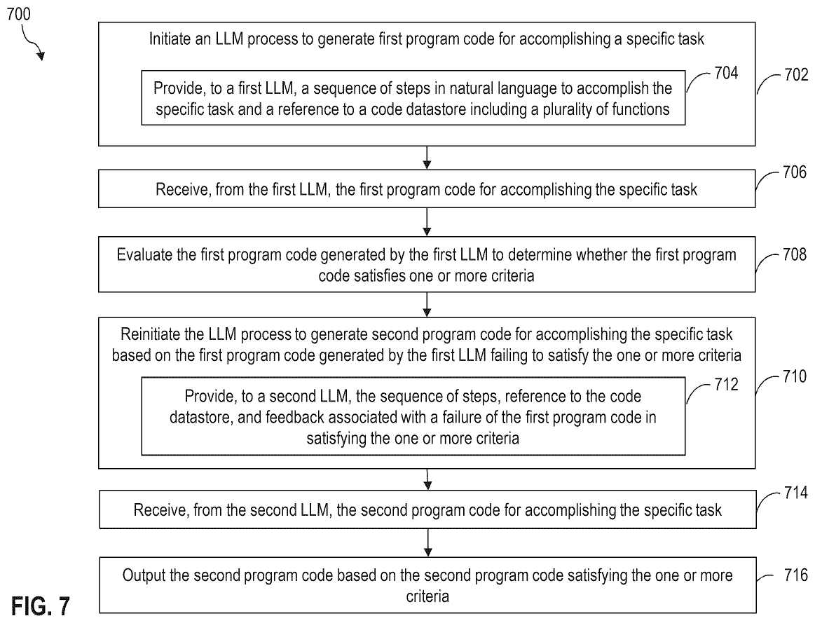

Turning now to FIG. 7, a method 700 is described. In an embodiment, the method 700 is a method for providing efficient, customizable AI-driven code generation from a natural language input prompt based on multiple large-language model (LLM) iterations with LLM iteration evaluation. The method 700 may include similar mechanisms as discussed above with reference to FIGS. 1-2, 3A-3B, and 4-6. The method 700 may be implemented by the natural language-based code generation agent 132. In embodiments, the method 700 may be implemented using a computer system with components as shown in FIG. 9. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, the natural language-based code generation agent 132 initiates an LLM process to generate first program code for accomplishing a specific task. At block 704, as part of initiating the LLM process, the natural language-based code generation agent 132 provides, to a first LLM 110, a sequence of steps in natural language to accomplish the specific task and a reference to a code datastore 140 including a plurality of functions 144. In some instances, the sequence of steps may be received from an input prompt (e.g., as discussed above with reference to FIGS. 3 and 5). In other instances, the sequence of steps may be determined based on a natural language target program code result received in an input prompt (e.g., as discussed above with reference to FIGS. 4 and 6). The plurality of functions 144 includes a plurality of base-level functions 144a and one or more composite functions 144b, each invoking two or more of the plurality of base-level functions 144a. At block 706, the natural language-based code generation agent 132 receives, from the first LLM 110, the first program code for accomplishing the specific task. The first program code includes a subset of the plurality of functions 144 of the code datastore 140.

At block 708, the natural language-based code generation agent 132 evaluates the first program code generated by the first LLM 110 to determine whether the first program code satisfies one or more criteria. In some instances, as part of evaluating the first program code, the natural language-based code generation agent 132 determines whether the first program code satisfies a constraint associated with at least one of a processing resource utilization or a memory resource utilization. In some instances, as part of evaluating the first program code, the natural language-based code generation agent 132 determines whether the first program code satisfies a constraint associated with at least one of a set of allowable functions 144 or a set of coding rules. In some instances, as part of evaluating the first program code, the natural language-based code generation agent 132 determines whether the first program is successfully compiled. In some instances, as part of evaluating the first program code, the natural language-based code generation agent 132 determines whether the first program code passes one or more functional tests (e.g., one or more predetermined test cases).

At block 710, the natural language-based code generation agent 132 reinitiates the LLM process based on the first program code generated by the first LLM 110 failing to satisfy the one or more criteria. At block 712, as part of the reinitiating, the natural language-based code generation agent 132 provides, to a second LLM 110, the sequence of steps in natural language, the reference to the code datastore 140, and feedback associated with a failure of the program code in satisfying the one or more criteria (from the evaluation at block 706). In some instances, the first LLM 110 used for generating the first program code has a different model attribute than the second LLM 110 used for generating the second program code. In other instances, the first LLM 110 used for generating the first program code is the same as the second LLM 110 used for generating the second program code.

At block 714, the natural language-based code generation agent 132 receives, from the second LLM 110, the second program code for accomplishing the specific task, where the second program code includes a second subset of the plurality of functions 144 of the code datastore 140. In some instances, the first subset of the plurality of functions 144 in the first program code is the same as the second subset of the plurality of functions 144 in the second program code. In other instances, the first subset of the plurality of functions 144 in the first program code includes at least one different function 144 than the second subset of the plurality of functions 144 in the second program code. That is, the second LLM 110 may map a certain step of the sequence of steps to a different function 144 than the first LLM 110. At block 716, the natural language-based code generation agent 132 outputs the second program code based on the second program code satisfying the one or more criteria.

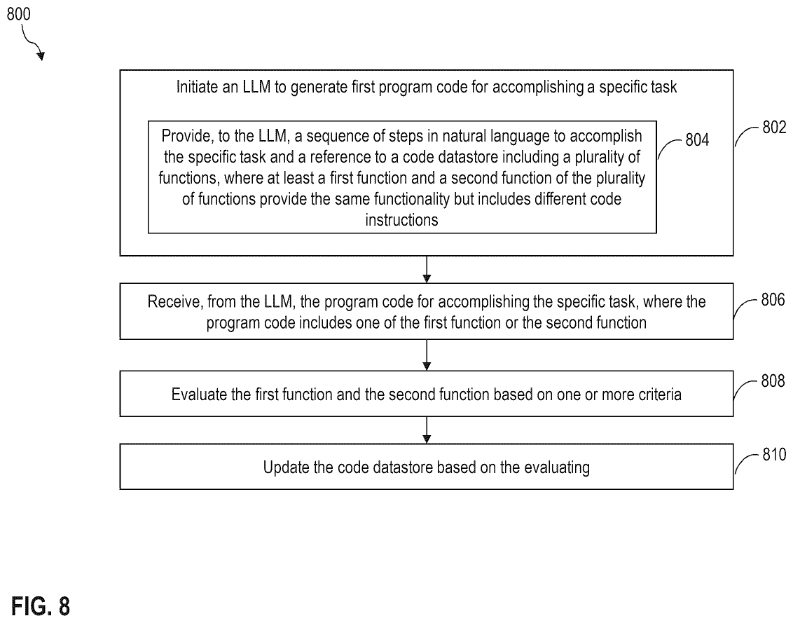

Turning now to FIG. 8, a method 800 is described. In an embodiment, the method 800 is a method for providing efficient, customizable AI-driven code generation from a natural language input prompt based on one or more LLMs 110 and a code datastore 140 with code datastore maintenance. The method 800 may include similar mechanisms as discussed above with reference to FIGS. 1-2, 3A-3B, and 4-7. The method 800 may be implemented by the natural language-based code generation agent 132. In embodiments, the method 800 may be implemented using a computer system with components as shown in FIG. 9. As illustrated, FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At block 802, the natural language-based code generation agent 132 initiates an LLM 110 to generate program code for accomplishing a specific task. At block 804, as part of initiating the LLM 110, the natural language-based code generation agent 132 provides, to the LLM 110, a sequence of steps in natural language to accomplish the specific task and a reference to a code datastore 140 including a plurality of functions 144, where at least a first function 144 and a second function 144 of the plurality of functions 144 provide the same functionality but comprises different code instructions (different implementations). In some instances, the first and second functions 144 may be composite functions 144b. In other instances, the first and second functions 144 may be base-level functions 144a. In some instances, the sequence of steps may be received from an input prompt (e.g., as discussed above with reference to FIGS. 3 and 5). In other instances, the sequence of steps may be determined based on a natural language target program code result received in an input prompt (e.g., as discussed above with reference to FIGS. 4 and 6).

The first function 144 and the second function 144 with the same functionality but different code instructions may be generated under various conditions. In some instances, the first function 144 in the code datastore 140 is generated as part of a first task (e.g., associated with a certain project or workflow automation) and the second function 144 in the code datastore 140 is generated as part of a second task (e.g., associated with a certain project or workflow automation) different than the first task. In some instances, the second function 144 is generated as part of second program code for a second task based on a failure of the second task when the first function 144 is being used for the second task. In some instances, the first function 144 in the code datastore 140 is generated by a first LLM 110 and the second function 144 in the code datastore 140 is generated by a second LLM 110 different than the first LLM 110. In such instances, the first LLM 110 that generated the first function 144 and the second LLM 110 that generated the second function 144 are of different LLM model types. In other instances, the first LLM 110 that generated the first function 144 and the second LLM 110 that generated the second function 144 are different versions of a particular LLM model type.

At block 806, the natural language-based code generation agent 132 receives, from the LLM 110, the program code for accomplishing the specific task, where the program code includes one of the first function 144 or the second function 144. The program code may also include one or more other functions 144 in the code datastore 140.

At block 808, the natural language-based code generation agent 132 evaluates the first function 144 and the second function 144 based on one or more criteria (e.g., as a post-processing process after outputting the program code at block 806). In some instances, the code datastore 140 further includes first metadata 146 associated with the first function 144 and second metadata 146 associated with the second function 144. Each of the first metadata 146 and the second metadata 146 includes information associated with at least one of a processing resource utilization of the respective function 144 (e.g., metadata field 206c), a memory resource utilization of the respective function 144 (e.g., metadata field 206d), a model type of an LLM 110 that generated the respective function 144 (e.g., metadata field 206e), a model version of an LLM that generated the respective function 144 (e.g., metadata field 206f), a number of successes associated with the respective function 144 (e.g., metadata field 206h), a number of failures associated with the respective function 144 (e.g., metadata field 206i), or a number of invocations of the respective function 144 (e.g., metadata field 206g) as discussed above with reference to FIG. 2. In such instances, the evaluating the first function 144 and the second function 144 is based on a comparison of the first metadata 146 (e.g., the respective metadata fields 206a to 206j) of the first function 144 and the second metadata 146 (e.g., the respective metadata fields 206a to 206j) of the second function 144.

At block 810, the natural language-based code generation agent 132 updates the code datastore 140 based on the evaluation at block 808. In some instances, as part of updating the code datastore 140, the natural language-based code generation agent 132 removes a lower performance one of the first function 144 or the second function 144 from the code datastore 140 (e.g., the one with the higher cycle count, higher memory usage, and/or higher error count or the one created by a lower performance or less robust LLM 110). In other instances, as part of updating the code datastore 140, the natural language-based code generation agent 132 assigns a first weighting value to the first function 144 and a second weighting value to the second function 144. The first weighting value is lower than the second weighting value based on the first function 144 having a lower performance than the second function 144 from the evaluation at block 808. The natural language-based code generation agent 132 further stores the first weighting value in association with first function 144 and the second weighting value in association with the second function 144 in the code datastore 140.

In some embodiments, the methods 300, 400, 500, 600, 700, and 800 discussed above with reference to FIGS. 3A-B, 4, 5, 6, 7, and 8, respectively can be combined in any suitable way to generate program code from natural language input, evaluate LLM generated program code with one or more iterations of LLM processing, and/or maintain a code datastore 140 including functions 144 that are used as building blocks for program code generation.

FIG. 9 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

### ADDITIONAL EMBODIMENTS

The following are non-limiting, specific embodiments in accordance with the present disclosure.

A first embodiment which is a computer-implemented method for providing artificial intelligence (AI)-driven program code generation from a natural language program code target result based on one or more large-language models (LLMs). The method comprises receiving, by a natural language-based code generation agent comprising instructions stored in non-transitory memory of a computer system and executable by a processor of the computer system, an input prompt comprising a target program code result in natural language. The method also comprises determining, by the natural language-based code generation agent, based on a function availability of a code datastore, a sequence of steps in natural language to provide the target program code result, wherein the code datastore comprises a plurality of functions, each in association with metadata comprising a textual description of at least one of a functionality or a function call interface of a respective one of the plurality of functions. The method additionally comprises initiating, by the natural language-based code generation agent, an LLM to generate, based on the code datastore and the determined sequence of steps, program code for providing the target program code result. The method also comprises receiving, by the natural language-based code generation agent, from the LLM, the program code for providing the target program code result, wherein the program code comprises a subset of the plurality of functions of the code datastore. The method further comprises outputting, by the natural language-based code generation agent, in response to the input prompt, the program code for providing the target program code result.

A second embodiment, which is the computer-implemented method of the first embodiment, wherein the plurality of functions of the code datastore comprises a plurality of base-level functions and one or more composite functions, each invoking at least two of the plurality of base-level functions.

A third embodiment, which is the computer-implemented method of the second embodiment, wherein the determining the sequence of steps to provide the target program code result comprises determining an individual step in the sequence of steps based on a corresponding function being available in the code datastore and a prioritization of the one or more composite functions over the plurality of base-level functions.

A fourth embodiment, which is the computer-implemented method of the first embodiment, wherein the determining the sequence of steps to provide the target program code result is based on a second LLM.

A fifth embodiment, which is the computer-implemented method of the fourth embodiment, wherein the second LLM for determining the sequence of steps is different than the LLM for generating the program code to provide the target program code result.

A sixth embodiment, which is the computer-implemented method of the fourth embodiment, wherein the second LLM for determining the sequence of steps is the same as the LLM for generating the program code to provide the target program code result.

A seventh embodiment, which is the computer-implemented method of the first embodiment, wherein the determining the sequence of steps to provide the target program code result is based on a determination that a function for providing the target program code result is unavailable in the code datastore.

An eight embodiment, which is the computer-implemented method of the first embodiment, further comprising mapping, by the natural language-based code generation agent, the determined sequence of steps to the subset of the plurality of functions of the code datastore, wherein the LLM is further initiated to generate the program code based on the mapped subset of the plurality of functions.

A ninth embodiment which is a computer-implemented method for providing artificial intelligence (AI)-driven program code generation from natural language input based on one or more large-language models (LLMs) and a code datastore with code datastore maintenance for efficiency improvement. The method comprises initiating, by a natural language-based code generation agent, an LLM to generate program code for accomplishing a specific task, wherein the initiating comprises providing, to the LLM, a sequence of steps in natural language to accomplish the specific task and a reference to a code datastore comprising a plurality of functions, wherein at least a first function and a second function of the plurality of functions provide the same functionality but comprises different code instructions. The method comprises receiving, by the natural language-based code generation agent, from the LLM, the program code for accomplishing the specific task. The program code comprises one of the first function or the second function. The method further comprises evaluating, by the natural language-based code generation agent, the first function and the second function based on one or more criteria and updating, by the natural language-based code generation agent, the code datastore based on the evaluating.

A tenth embodiment, which is the computer-implemented method of the ninth embodiment, wherein the evaluating the first function and the second function comprises comparing the first function and the second function based on at least one of: a processing resource utilization of the respective function, a memory resource utilization of the respective function, a model type of an LLM that generated the respective function, a model version of an LLM that generated the respective function, a number of successes associated with the respective function, a number of failures associated with the respective function, or a number of invocations of the respective function.

An eleventh embodiment, which is the computer-implemented method of the tenth embodiment, wherein the code datastore further comprises first metadata associated with the first function and second metadata associated with the second function, and each of the first metadata and the second metadata comprises information associated with the at least one of: the processing resource utilization of the respective function, the memory resource utilization of the respective function, the model type of an LLM that generated the respective function, the model version of an LLM that generated the respective function, the number of successes associated with the respective function, the number of failures associated with the respective function, or the number of invocations of the respective function, or the comparing the first function and the second function is based on a comparison of the first metadata associated with the first function and the second metadata associated with the second function.

A twelfth embodiment, which is the computer-implemented method of the ninth embodiment, wherein the updating the code datastore comprises removing, by the natural language-based code generation agent, a lower performance one of the first function or the second function from the code datastore.

A thirteenth embodiment, which is the computer-implemented method of the ninth embodiment, wherein the updating the code datastore comprises: assigning, by the natural language-based code generation agent, a first weighting value to the first function and a second weighting value to the second function, wherein the first weighting value is lower than the second weighting value based on the first function having a lower performance than the second function from the evaluation; and storing, by the natural language-based code generation agent, in the code datastore, the first weighting value in association with the first function and the second weighting value in association with the second function.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer-implemented method for providing artificial intelligence (AI)-driven program code generation from a natural language input prompt based on multiple large-language model (LLM) iterations with LLM iteration evaluation, the method comprising:
initiating, by a natural language-based code generation agent, an LLM process to generate first program code for accomplishing a specific task, wherein the initiating comprises:
providing, to a first LLM, a sequence of steps in natural language to accomplish the specific task and a reference to a code datastore comprising a plurality of functions;
receiving, by the natural language-based code generation agent, from the first LLM, the first program code for accomplishing the specific task, wherein the first program code comprises a subset of the plurality of functions of the code datastore;
evaluating, by the natural language-based code generation agent, the first program code generated by the first LLM to determine whether the first program code satisfies one or more criteria; and
reinitiating, by the natural language-based code generation agent, the LLM process to generate second program code for accomplishing the specific task based on the first program code generated by the first LLM failing to satisfy the one or more criteria, wherein the reinitiating the LLM process comprises:
providing, to a second LLM, the sequence of steps in natural language, the reference to the code datastore, and feedback associated with a failure of the first program code in satisfying the one or more criteria;
receiving, by the natural language-based code generation agent, from the second LLM, the second program code for accomplishing the specific task, wherein the second program code comprises a second subset of the plurality of functions of the code datastore; and
outputting, by the natural language-based code generation agent, the second program code based on the second program code satisfying the one or more criteria.

2. The method of claim 1, wherein the evaluating comprises:
determining, by the natural language-based code generation agent whether the first program code satisfies a constraint associated with at least one of a processing resource utilization or a memory resource utilization.

3. The method of claim 1, wherein the evaluating comprises:
determining, by the natural language-based code generation agent, whether the first program code satisfies a constraint associated with at least one of a set of allowable functions or a set of coding rules.

4. The method of claim 1, wherein the evaluating comprises:
determining, by the natural language-based code generation agent, whether the first program code is successfully compiled.

5. The method of claim 1, wherein the evaluating comprises:
determining, by the natural language-based code generation agent, whether the first program code passes one or more predetermined test cases.

6. The method of claim 1, wherein the plurality of functions of the code datastore comprises:
a plurality of base-level functions; and
one or more composite functions, each invoking two or more of the plurality of base-level functions.

7. The method of claim 1, wherein the first LLM initiated for generating the first program code has a different model attribute than the second LLM initiated for generating the second program code.

8. The method of claim 1, wherein the first LLM initiated for generating the first program code is the same as the second LLM initiated for generating the second program code.

9. A computer-implemented method for providing efficient artificial intelligence (AI)-driven program code generation from natural language step-by-step processes based on one or more large-language models (LLMs) with composite function generation, the method comprising:
receiving, by a natural language-based code generation agent comprising instructions stored in non-transitory memory of a computer system and executable by a processor of the computer system, an input prompt comprising a natural language step-by-step process, wherein the natural language step-by-step process comprises a sequence of steps associated with a specific task;
analyzing, by the natural language-based code generation agent, the sequence of steps against a function availability of a code datastore comprising a plurality of functions, wherein the plurality of functions comprises a plurality of base-level functions and one or more composite functions, each invoking at least two of the plurality of base-level functions, wherein the analyzing comprises:
determining whether there is a match between at least two steps of the sequence of steps and a first composite function of the one or more composite functions;
generating, based on determining the match between the at least two steps and the first composite function, a shortened sequence of steps by combining the at least two steps; and
mapping the shortened sequence of steps to a subset of the plurality of functions comprising the first composite function;
initiating, by the natural language-based code generation agent, an LLM to generate, based on the mapped subset of the plurality of functions, program code for the shortened sequence of steps;
receiving, by the natural language-based code generation agent, from the LLM, the program code for the natural language step-by-step process; and
outputting, by the natural language-based code generation agent, in response to the input prompt, the LLM generated program code.

10. The method of claim 9, wherein:
the code datastore further comprises metadata comprising a textual description of at least one of a functionality or a function call interface for each respective one of the plurality of functions, and
the analyzing the sequence of steps in the natural language step-by-step process against the function availability of the code datastore is further based on the metadata.

11. The method of claim 9, wherein the analyzing the sequence of steps in the natural language step-by-step process against the function availability of the code datastore is further based on a second LLM.

12. The method of claim 9, further comprising:
analyzing, by the natural language-based code generation agent, based on one or more criteria, the subset of the plurality of functions in the LLM generated program code to generate a second composite function that combines at least two functions of the subset of the plurality of functions;
generating, by the natural language-based code generation agent, metadata for the second composite function, wherein the generated metadata comprises a textual description of at least one of a functionality or a function call interface of the second composite function; and
storing, by the natural language-based code generation agent, the second composite function in association with the generated metadata in the code datastore.

13. The method of claim 12, wherein:
the analyzing the subset of the plurality of functions in the LLM generated code to generate the second composite function is further based on a second LLM, and
the generated metadata for the second composite function further comprises at least one of an LLM model type or an LLM model version associated with the second LLM that generated the second composite function.

14. The method of claim 9, wherein:
the input prompt further comprises an indication of an application category associated with the natural language step-by-step process,
the code datastore further comprises a plurality of function libraries, each associated with a different application category and comprising a set of functions,
the sequence of steps in the natural language step-by-step process is analyzed further against a first function library of the plurality of function libraries based on a match between the application category associated with the natural language step-by-step process and an application category associated with the first function library, and
the plurality of functions correspond to a respective set of functions in the first function library.

15. A computer-implemented method for providing artificial intelligence (AI)-driven program code generation from natural language input based on one or more large-language models (LLMs) and a code datastore with code datastore maintenance for efficiency improvement, the method comprising:
initiating, by a natural language-based code generation agent, an LLM to generate program code for accomplishing a specific task, wherein the initiating comprises:
providing, to the LLM, a sequence of steps in natural language to accomplish the specific task and a reference to a code datastore comprising a plurality of functions, wherein at least a first function and a second function of the plurality of functions provide the same functionality but comprises different code instructions;
receiving, by the natural language-based code generation agent, from the LLM, the program code for accomplishing the specific task, wherein the program code comprises one of the first function or the second function;
evaluating, by the natural language-based code generation agent, the first function and the second function based on one or more criteria; and
updating, by the natural language-based code generation agent, the code datastore based on the evaluating.

16. The method of claim 15, wherein the first function in the code datastore is generated as part of a first task, and wherein the second function in the code datastore is generated as part of a second task different than the first task.

17. The method of claim 16, wherein the second function is generated as part of second program code for the second task based on a failure of the second task when the first function is being used for the second task.

18. The method of claim 15, wherein the first function in the code datastore is generated by a first LLM, and wherein the second function in the code datastore is generated by a second LLM different than the first LLM.

19. The method of claim 18, wherein the first LLM that generated the first function in the code datastore and the second LLM that generated the second function in the code datastore are of different LLM model types.

20. The method of claim 18, wherein the first LLM that generated the first function in the code datastore and the second LLM that generated the second function in the code datastore are different versions of a particular LLM model type.
